(19) United States
(12) Patent Application Publication
(10) Pub. No.: US 2022/0305498 A1
(43) Pub. Date: Sep. 29, 2022

(54) MEDIA DECLASSIFICATION DEVICE

(71) Applicants: Thomas Delahunty, Milford, MA (US); Eugene McCabe, Milford, MA (US)

(72) Inventors: Thomas Delahunty, Milford, MA (US); Eugene McCabe, Milford, MA (US)

(21) Appl. No.: 17/704,391

(22) Filed: Mar. 25, 2022

Related U.S. Application Data
(60) Provisional application No. 63/166,446, filed on Mar. 26, 2021.

(51) Int. Cl. B02C 23/16; B02C 18/00; B02C 18/14; B02C 18/22

(52) U.S. Cl. CPC B02C 23/16; B02C 18/0007; B02C 18/14; B02C 18/2216; B02C 2023/165; B02C 2018/0015

(57) ABSTRACT

A media declassification device receives a media component such as an SSD or magnetic disk drive, and eradicates any remnants of sensitive data stored thereon by physical agitation and dismantling the media component. A cutting wheel or die rotates in close tolerance to an interior surface of a cutting chamber, and cutters or protrusions on the cutting wheel engage the media component against a leading edge of the cutting chamber for shearing and/or cutting fragments of the media component into the cutting chamber. A screen at an opposed side of the cutting chamber has apertures that limit a maximum size of particles passing out of the cutting chamber.

### RELATED APPLICATIONS

This patent application claims the benefit under 35 U.S.C. § 119(e) of U.S. Provisional Patent App. No. 63/166,446, filed Mar. 26, 2021, entitled “MEDIA DECLASSIFICATION DEVICE,” incorporated herein by reference in entirety.

### BACKGROUND

Modern electronic proliferation of information has led to a tremendous quantity of data, sensitive and otherwise, being stored in electronic form, typically in non-volatile memory such as SSDs (solid state drives) and magnetic media. Deletion of sensitive information from electronic sources can be elusive, however. Many deletion operations merely reflag or designate areas corresponding to deleted data as available for new data, without actually overwriting. Direct access mechanisms, which access media on a location basis, rather then through a file system, can bypass the deletion flags and effectively access “deleted” data. Further, even when data is overwritten with new data, techniques exist to recover residual indications of previously stored data.

### SUMMARY

A media declassification device receives a media component such as an SSD or magnetic disk drive, and eradicates any remnants of sensitive data stored thereon by physical agitation and dismantling the media component. A cutting wheel or die rotates in close tolerance to an interior surface of a cutting chamber, and cutters or protrusions on the cutting wheel engage the media component against a leading edge of the cutting chamber for shearing and/or cutting fragments of the media component into the cutting chamber. A screen at an opposed side of the cutting chamber has apertures that limit a maximum size of particles passing out of the cutting chamber.

Configurations herein are based, in part, on the observation that it can be problematic to ensure complete erasure of data from storage media once the media has been taken out of service. Data security techniques often impose requirements of overwriting and unreadability for decommissioned media; in the case of governmental regulations governing sensitive or classified data, physical dismantling of media to a particle size deemed unreadable is required to render formerly classified data as “declassified.” Unfortunately, conventional approaches to media/drive declassification suffer from the shortcoming than conventional dismantling techniques for decommissioned media often employ a hammermill or similar approach for physical pulverizing of media storage devices. Such devices have alternating sized voids for passing pulverized pieces. It can be difficult to ensure that large sized pieces cannot pass into the waste stream; in other words, to ensure that all pieces in the stream are no larger than a minimum size.

### BRIEF DESCRIPTION OF THE DRAWINGS

The foregoing and other objects, features and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a schematic workflow of the media declassification device as defined herein;

FIG. 2 shows a perspective view of a media declassification device as defined herein;

FIG. 3 shows a block diagram of a method and system of media declassification in the workflow of FIG. 1;

FIG. 4 shows a perspective view of the agitator of FIG. 2 for dismantling media components;

FIG. 5 shows a schematic view of the underside of the enclosure around the agitator of FIG. 4;

FIG. 6 shows a deployed declassification cart housing the declassification device of FIG. 1-5;

FIG. 7 shows an alternate configuration of the agitator of FIGS. 4 and 5; and

FIG. 8 shows a cutaway view of the agitator of FIG. 7.

### DETAILED DESCRIPTION

Depicted below are several examples of a media declassification device according to configurations herein. Physical dismantling of the media device is shown, including severing fragments of the existing storage media and any accompanying enclosure, and further agitating the severed fragments into particles sufficiently small to be considered unintelligible and unreadable of the information formerly stored therein, and therefore appropriate for declassification. A sufficiently small size for declassification may vary according to an external standard, but is around 2 mm.

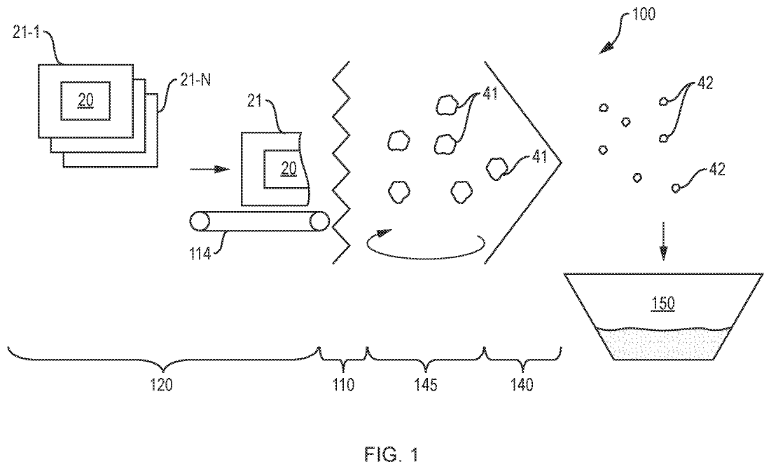

FIG. 1 shows a schematic workflow of the media declassification device as defined herein. Referring to FIG. 1, in a data security environment 100 having a stream 120 of retired mass storage devices 21-1 . . . 21-N (21 generally) having a storage media component 20 (media component) used for sensitive data storage, a declassification apparatus renders the storage media unintelligible. A severing entity 110 such as an agitator or grinding wheel is responsive to mechanical actuation for severing fragments 41 of the media component 20, along with incidental casing and connections, generally in a comingled manner. Alternatively, the media component 20 may be manually separated prior, but this is not necessary. A feed mechanism 114, such as rollers, belts and/or chutes provides conveyance of the media component 20 to the agitator for forcibly engaging the agitator with the storage media.

A sizing regulator 140 passes fragments 41 within a maximum particle size, meaning equal to or smaller than a size deemed unreadable, such as 2 mm. The agitator is responsive to mechanical actuation for fragmenting the storage media against a sizing regulator 140 including a sieved surface or entity. The sieved surface is rigid with apertures or perforations based on the maximum particle size. Severed fragments 41 of a sufficiently small size pass as particles 42 into a repository 150 for declassified waste. Not all severed fragments 41 may be sufficiently small for passage as particles 42. In contrast to conventional approaches, which merely pass all output from a hammermill, shredder and similar dismantling, the approach herein provides a cyclic pathway 145 for redirecting fragments 41 exceeding the maximum particle size back to the agitator for successive agitation. The sizing regulator 140 is disposed near the agitator based on a tolerance for further shearing the fragments and particles exceeding the maximum particle size. Sheared fragments continue agitation as the agitator grinds and shears in a close tolerance against the sieved surface, and surrounding enclosure, to ensure continual shearing of fragments until a sufficiently small particle size is achieved.

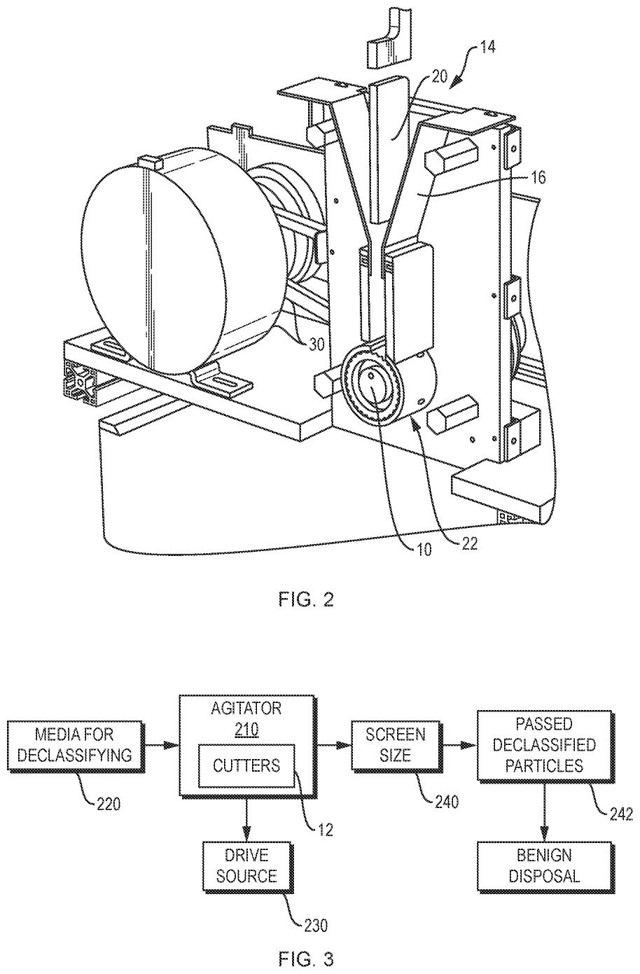

FIG. 2 shows a perspective view of a particular example configuration of a media declassification device as in FIG. 1. Configurations herein substantially overcome the shortcomings of conventional hammermill and arbitrary particle size approaches by providing a media declassification device including an agitator 10 having a plurality of circumferential cutters, edges or teeth. A feed opening 14 is defined by a feed chute 16, and is adapted to receive a media component 20 and pass the media component into engagement with the agitator 10. An enclosure 22 around the agitator is disposed for engaging the media component 20 into an interference arrangement with the agitator 10. An actuator such as a belt drive motor 30 connects to the agitator for disposing the cutters in an agitating engagement with the media component 20 by rotating the agitator 10. An adjustable wall 24 aligns with a leading edge 26 of the enclosure 22 for guiding the media component into an interference arrangement with the cutters on the rotating agitator 10 to effectively grind and shred the media component 20 into unreadable fragments.

FIG. 3 shows a block diagram of a method and system of media declassification in the workflow of FIG. 1. Referring to FIGS. 1-3, the method for declassifying storage media 21 having sensitive data by rendering the storage media into an unreadable physical form includes disposing a batch 220 of storage media through a severing entity 210 configured for severing fragments 41 of the storage media 20. In the configuration of FIG. 2, this includes rotating the agitator 10 via a drive source 230 for severing the fragments 41 from the storage media and for shearing the severed fragments against a sieving entity 240 for evaluating fragments 41 small enough to pass the sieving entity 240. Storage media 21 is forced via a feed mechanism for conveyance of the media component 20 and associated casing to the agitator for forcibly engaging the agitator with the storage media at a speed based on an intended size of the severed fragments 41.

The sizing regulator 140 may be fulfilled by a sieving entity 240 having an array of apertures, where a tolerance is based on an interference between the agitator and the sieving entity for shearing the particles unable to pass the apertures. The sieving entity 240 has a mesh, screen or apertures with a screen size for effectively evaluating the severed fragments 41 for a size smaller than a maximum particle size. The output bin 150 catches passed particles 242 of the severed fragments 41 as declassified media particles if meeting the maximum particle size. Agitation continues the severed fragments 41 until smaller than the maximum particle size for passing as declassified media particles 42. The aggregated, comingled particles form benign disposal 244 material for waste or recycling.

Continuing to refer to the example of FIG. 2, severing the fragments further include rotating the agitator 10 in an enclosure 22, where the storage media is forcibly disposed against cutters, blades or teeth on the agitator 10 for physically severing the fragments 41. Fragments of an excessive size continue to be sheared against the enclosure and the sieving entity 240 until sufficiently small to pass through apertures in the sieving entity. The agitator 10 includes an array of cutters 12 adapted to rotate in the enclosure 22. The enclosure having an input for shearing fragments 41 of the storage media and an output for disposing the sheared fragments 41 against the sieved surface for shearing particles 41 to a size defined by apertures of the sieved surface.

A size of the severed fragments 41 is based on a feed speed and a rotation speed, and a size of the sieved particles 42 is based on an aperture size of the sieved surface. This remedies a problem in the prior art where initially severed or dismantled portions are too large to be considered unreadable. Initially “large” fragments 41 continue shearing until small enough to pass as particles 42. A further advantage of the cyclic, rotating agitator is actuation for severing the fragments of the storage media 21 and shearing the fragments 41 into particles 42 based on the same rotational movement.

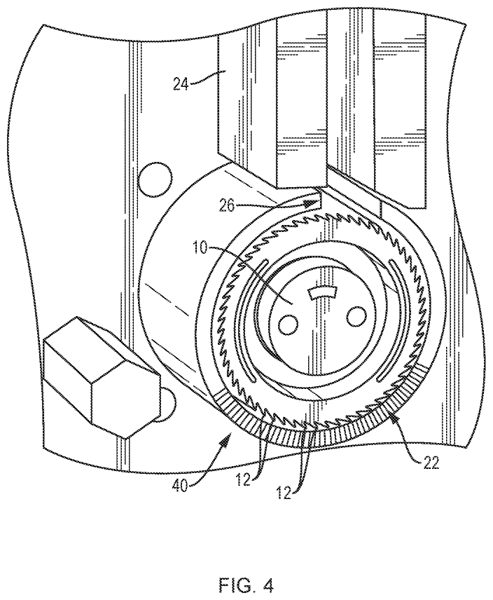

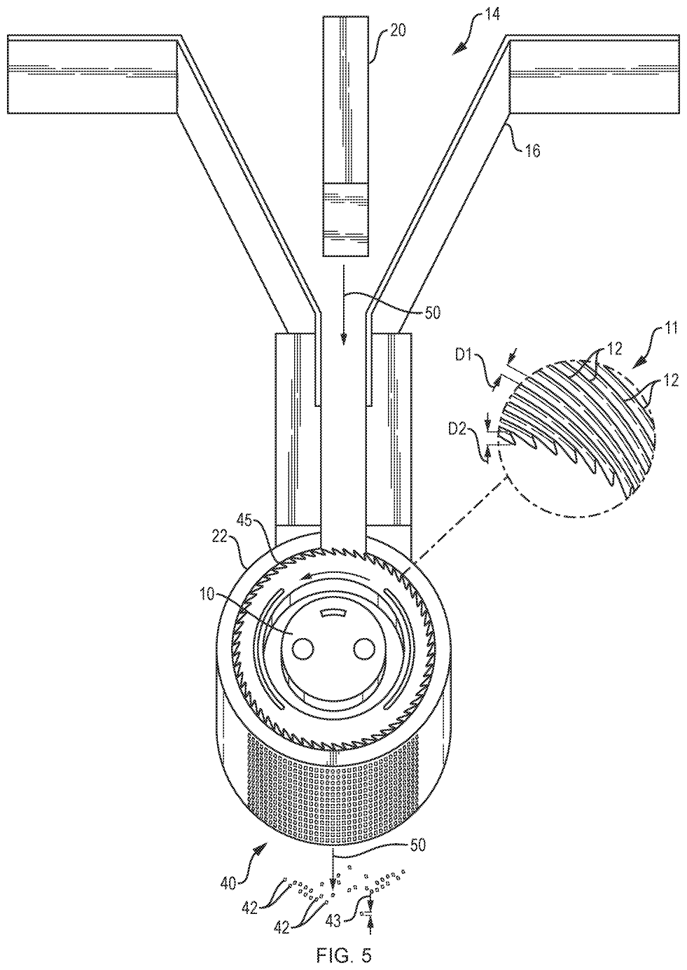

FIG. 4 shows a perspective view of an agitator for dismantling media components, and FIG. 5 shows a schematic view of the underside of an enclosure around the agitator. In FIGS. 4 and 5, the agitator 10 has an annular surface 11 and the cutters 12 extend in a staggered manner across the annular surface 11. The cutters 12 are spaced laterally by a width D1 and longitudinally D2 based on a maximum size of the separated, cut fragments. In an example configuration, fragments should be no larger than 2 mm, however this sizing may be adjusted to suit the applicable requirements.

The enclosure 22 has a screen 40 at an opposed side from the feed opening 14 with apertures sized based on the maximum particle size 43. The screen 40 is disposed adjacent the agitator 10 and aligned with the enclosure 22 for engaging the particles cut or sheared by the cutters 12. It should be apparent that the screen 40 is adapted to pass the particles 42 from the enclosure through apertures based on the maximum particle size, such that larger particles simply advance around the enclosure 22 for additional agitation and cutting until sufficiently small to pass through the screen 40.

The agitator 10, in the example configuration, takes the form of a cutting wheel or drum defining the plurality of cutters in an interleaving arrangement of protrusions, such that the interleaved arrangement defines the spacing D1, D2 based on the maximum particle size 43. The round cutting drum shape rotationally couples to a drive source, such that the rotating agitator is adapted to engage the media component 20 in a severing communication against the enclosure 22 as particles 42 disengaged from the media component 20 may be iteratively agitated in the enclosure until sufficiently small to pass through the screen 40. A tolerance 45 between the agitator 10 and the enclosure 22 allows cyclic travel and successive shearing against the enclosure 22 until broken into particles small enough to pass the screen 40. A variety of cutting drums may be considered based on an ability to shear or disengage appropriately sized particles in conjunction with an appropriate screen. Generally, the cutting drum exhibits a discontinuous blade structure such as the interleaved cutters 12, so as to avoid cutting a pattern of elongated strips of material.

A further consideration involves a downward force on the media component 20 for biasing it into a cutting engagement. A mechanical plunger may be employed in the chute 16 to force the media component against the agitator. Other suitable conveyance means may be employed for drawing the media component into engagement with the agitator and biasing the particles through the screen, such as a frictional roller 114 or conveyor, gaseous currents or low pressure bias (i.e. vacuum suction), magnetic and gravitational mechanisms.

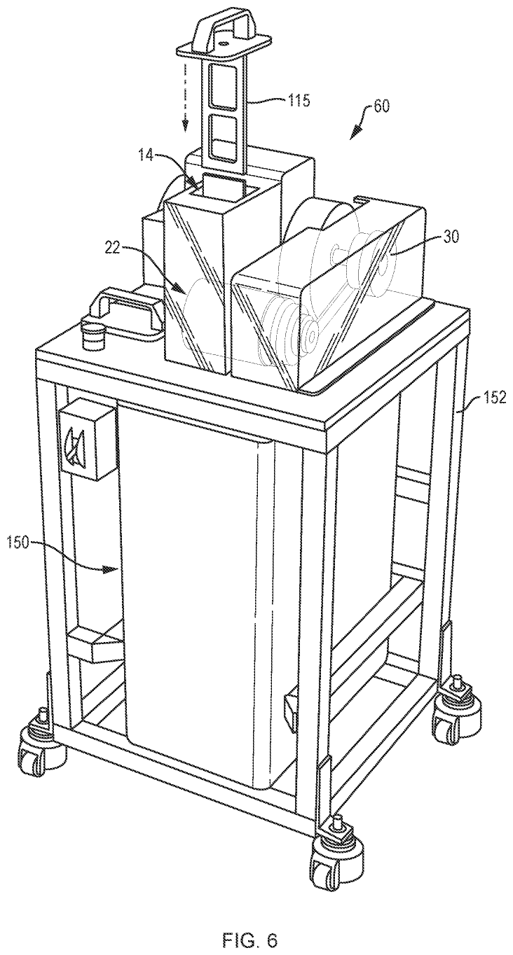

FIG. 6 shows a deployed declassification cart housing the declassification device of FIG. 1-5. Referring to FIGS. 1-6, the full declassification apparatus 60 may be installed in a cart 152 for storing the output bin 150 below for catching the particles 42. A plunger 115 may supplement the feed mechanism or rollers 114 for feeding the storage media 21 iteratively. The feed opening 14 is disposed at a workable height for successive manual feeding by an operator. The belt drive 30 is enclosed for safety.

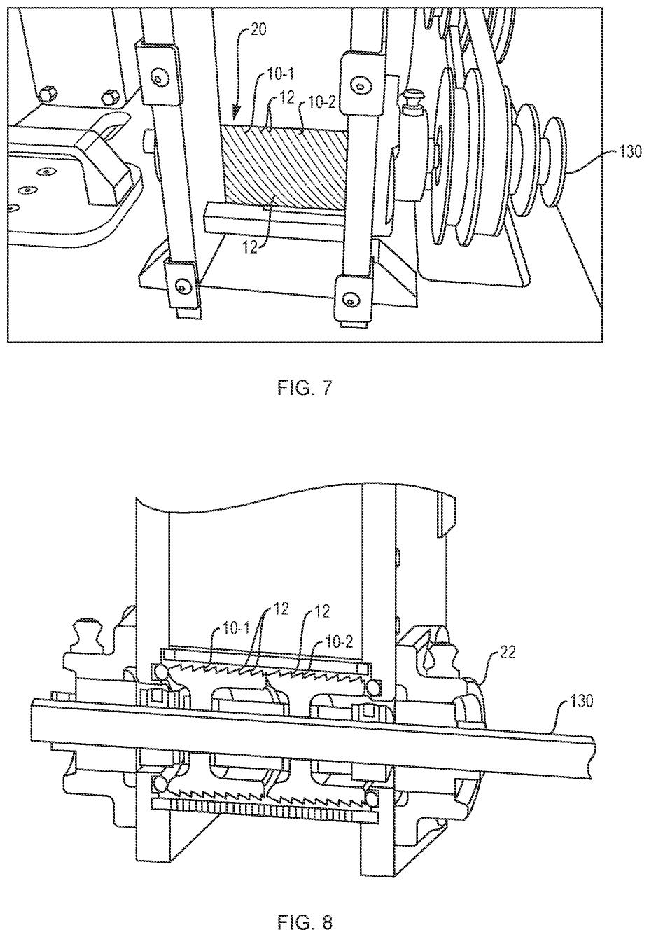

FIG. 7 shows an alternate configuration of the agitator of FIGS. 4 and 5, where the agitator includes adjacent portions 10-1, 10-2 with cutters 12 in rows skewed by a helical or diagonal from a rotational axis of the shaft 130. The enclosure 22 may be clear for observing function or may have a removable cover.

FIG. 8 shows a cutaway view of the agitator of FIG. 7, where the dual portions 10-1, 10-2 are shown adjacent on the shaft 130.

While the system and methods defined herein have been particularly shown and described with references to embodiments thereof, it will be understood by those skilled in the art that various changes in form and details may be made therein without departing from the scope of the invention encompassed by the appended claims.

What is claimed is:

1. In a data security environment having a stream of retired mass storage devices having a storage media used for sensitive data storage, a declassification apparatus for rendering the storage media unintelligible, comprising:
an agitator responsive to mechanical actuation for severing fragments of the storage media;
a sizing regulator for passing fragments within a maximum particle size; and
a cyclic pathway for redirecting fragments exceeding the maximum particle size to the agitator for successive agitation.

2. The device of claim 1 wherein the agitator is responsive to mechanical actuation for fragmenting the storage media against a sieved surface.

3. The device of claim 1 wherein the sizing regulator has a plurality of apertures, each aperture defined based on the maximum particle size.

4. The device of claim 1 wherein the sizing regulator is disposed near the agitator based on a tolerance, the tolerance for shearing the particles exceeding the maximum particle size.

5. The device of claim 4 wherein the sizing regulator is a sieving entity having an array of apertures, the tolerance based on an interference between the agitator and the sieving entity for shearing the particles unable to pass the apertures.

6. The device of claim 1 wherein the agitator is actuated for severing the fragments of the storage media and shearing the fragments into particles based on the same rotational movement.

7. The device of claim 1 wherein a size of the severed fragment is based on a feed speed and a rotation speed, and a size of the sieved particles is based on an aperture size of the sieved surface.

8. The device of claim 1 wherein the agitator further includes cutters adapted to rotate in an enclosure, the enclosure having an input for shearing fragments of the storage media and an output for disposing the sheared fragments against the sieved surface for shearing particles to a size defined by apertures of the sieved surface.

9. The device of claim 7 further comprising a feed mechanism for conveyance of the media component to the agitator for forcibly engaging the agitator with the storage media.

10. A method for declassifying storage media having sensitive data by rendering the storage media into an unreadable physical form, comprising:
disposing the storage media through a severing entity, the severing entity configured for severing fragments of the storage media;
evaluating the severed fragments for a size smaller than a maximum particle size;
passing particles of the severed fragments as declassified media particles if meeting the maximum particle size; and
continuing agitating the severed fragments until smaller than the maximum particle size for passing as declassified media particles.

11. The device of claim 10 further comprising rotating an agitator for severing the fragments from the storage media and for shearing the severed fragments against a sieving entity for evaluating fragments small enough to pass the sieving entity.

12. The method of claim 10 wherein severing the fragments further comprises:
rotating an agitator in an enclosure,
disposing the storage media disposed against the agitator for severing the fragments; and
shearing fragments of an excessive size against the enclosure and the sieving entity until sufficiently small to pass through apertures in the sieving entity.

13. The method of claim 10 further comprising advancing the storage media via a feed mechanism for conveyance of the media component to the agitator for forcibly engaging the agitator with the storage media at a speed based on an intended size of the severed fragments.

14. A media declassification device, comprising:
an agitator having a plurality of cutters;
a feed opening, the feed opening adapted to receive a media component and pass the media component into engagement with the agitator;
an enclosure around the agitator, the enclosure disposed for engaging the media component into an interference arrangement with the agitator; and
an actuator connected to the agitator for disposing the cutters in an agitating engagement with the media component.

15. The device of claim 14 wherein the agitator has an annular surface and the cutters extend in a staggered manner across the annular surface.

16. The device of claim 14 further comprising a screen,
the screen disposed adjacent the agitator and aligned with the enclosure for engaging particles cut or sheared by the cutter, the screen adapted to pass particles from the enclosure, the screen having apertures based on a maximum particle size.

17. The device of claim 14 further comprising a cutting drum defining the agitator, the cutting drum defining the plurality of cutters in an interleaving arrangement of protrusions, the interleaved arrangement defining a spacing based on the maximum particle size.

18. The device of claim 14 wherein the actuator is a drive source rotationally connected to the agitator, the agitator adapted to engage the media component in a severing communication against the enclosure.

19. The device of claim 17 further comprising a conveyance drive, the conveyance drive for drawing the media component into engagement with the agitator and biasing the particles through the screen.

20. The device of claim 19 wherein the conveyance means includes at least one of friction rollers, gaseous currents, magnetic and gravitational mechanisms.
